(19) United States
(12) Patent Application Publication
(10) Pub. No.: US 2015/0248688 A1
(43) Pub. Date: Sep. 3, 2015

(54) METHOD FOR OBTAINING INFORMATION

(71) Applicant: Klaus Peter RAUNECKER, Ulm (DE)

(72) Inventor: Klaus Peter Raunecker, Ulm (DE)

(21) Appl. No.: 14/425,343

(22) PCT Filed: Sep. 4, 2013
(86) PCT No.: PCT/EP2013/068232

§ 371 Date: Mar. 3, 2015

(30) Foreign Application Priority Data
Sep. 4, 2012 (DE) 10 2012 017 428.4

(51) Int. Cl. G06Q 30/02; G06Q 10/06

(52) U.S. Cl. CPC G06Q 30/0217; G06Q 10/0631; G06Q 50/184

(57) ABSTRACT

A method for ascertaining a sought piece of information by involving a plurality of subscribers. The subscribers are set a search task by an initiator and the one or more subscribers that assist with delivering a sought piece of information have the prospect of a reward. Even subscribers that, although not delivering the sought piece of information, play a part in identifying the subscriber that delivers the sought piece of information have the prospect of a share of the reward.

This application is a National Stage completion of PCT/EP2013/068232 filed Sep. 4, 2013, which claims priority from German patent application serial no. 10 2012 017 428.4 filed Sep. 4, 2012.

### FIELD OF THE INVENTION

The invention relates to a method for obtaining information by involving a plurality of participants, particularly to a method for ascertaining prior art that is relevant to pending or granted industrial property rights.

### BACKGROUND OF THE INVENTION

Registered or granted patents or other industrial property rights are a considerable factor of influence on the financial activity of a large number of participants in economic life. Often, decisions about product introductions are made on the basis of property rights of third parties. In extreme cases, useful products fail to reach the market solely because a property right of a third party is an arduously calculable risk for marketing the product without the third party —the property right, holder—itself producing or prompting the production. of or applying the subject matter of its patent itself. Furthermore, the large number of property rights in force has led to it now being virtually impossible to assess whether a planned, product is free of claims for neglect or damages from third parties at reasonable cost.

When a market player is confronted, with the charge of infringing an industrial property right, particularly a patent, said market player usually enters a two-stage examination. First of all, it is established whether the facts of the infringement that are asserted by the property right holder actually exist. If this is the case, the legal validity of the property right is usually examined by the alleged infringer. To this end, the latter will usually consult the grant documents and perform its own searches for prior art that was not known to the granting patent office at. the time of granting. It is not seldom that such examination unearths prior art that can be assessed as far more relevant than the prior art found by the examiner entrusted with the case in the filing procedure. Particularly non-patent literature or also instances of prior public use are frequently found to be highly relevant in this case to the assessment of the legal validity of a property right, since the information in this regard is usually not available to the patent examiners or can be searched far less conveniently than patent literature. Corresponding searches are decidedly costly at present, however, and often the party affected by the infringement charge shrinks from this considerable financial cost, which ultimately leads to—unjust—respect for a property right that cannot be regarded as legally valid in light of the whole prior art.

### SUMMARY OF THE INVENTION

It is an object of the present invention to specify a method for obtaining information, particularly for ascertaining prior art for industrial property rights, that allows an efficient search at calculable total, cost.

The method according to the invention for ascertaining a sought piece of information is effected by involving a plurality of participants, wherein the participants are set a search task by an initiator. Those participants who supply a sought piece of information are provided with the prospect of a reward. However, even participants who f although not supplying the sought piece of information, contribute to identifying a participant who supplies a sought piece of information are provided with the prospect of a share of the reward.

The method can also proceed semiautomatically or fully automatically, in particular. In this case, the initiator may be an electronic system, such as a computer system or also a smart phone, that uses communication links, such as the Internet or also mobile radio networks, to set the participants the search task.

By way of example, the first participants contacted can likewise be identified

semiautomatically or fully automatically. In this way, the system serving as initiator can first of all be provided with the search task in machine-readable form.

In particular, a patent document, for example, or another document can first of all be subjected to a computer-based semantic analysis, so that in a second step—if appropriate using indistinct fuzzy logic—it is possible to identify documents with related content from publicly accessible sources such as patent or literature databases. This can also involve the application of text mining methods, in particular.

In a further step, it is then possible—in manual or automated fashion—to extract the names of the respective authors of the documents found. The structured bibliographic information that is usually stored in the databases addressed means that this step can also be automated at manageable cost.

The identified persons can then subsequently be contacted if appropriate by automatically generated messages in order so inform the persons, that is to say the participants, of the search task and of the conditions of contribution. Such contacting can naturally also take place with the cooperation of a real person.

The aforementioned semantic analysis both of the first document and of the subsequently identifiable document can additionally be combined with machine learning methods.

Both the (semi) automated identification and information of the first participants and the provision of the prospect of a reward for the proliferation of the search task achieve a much improved broad impact of the search, for the piece of information currently of interest. Anyone who, although unable to supply the piece of information himself, knows a person or knows of a person who could supply the sought piece of information will, on account of his stake in a possible reward, show increased motivation to contact this person and inform, him of the question asked or to provide the initiator with a reference to this person.

By way of example, contacting the person can involve a simple e-mail with the relevant question, so that the cost associated wish contacting is minimal. Ideally, this initiates a virtually worldwide, parallel search for the relevant piece of information, giving much improved prospects of success in comparison with conventional, methods.

The reward can be paid to the contributing participants different shares, in particular the participant who supplies the sought piece of information himself can receive the highest share of the reward. This increases the motivation of the participants to search for the piece of information themselves.

The share for a participant contributing to identify the aforementioned participant can be calculated according to the position of said contributing participant within the number of participants contributing to the identification. In particular, the one who identifies the supplier of the sought piece of information can receive the second highest, share of the reward after the supplier himself. Within a chain of participants that are used to identify the supplier of the sought piece of information, the reward can be scaled so as to ascend in the direction of the supplier. This measure ensures that the participants contact those persons who, from their point of view, have the highest potential for finding the sought piece of information as a matter of priority. Not necessarily all persons contributing in the chain need to receive a share in this case, it is also conceivable for this to be limited to the last two or three links in the chain, for example.

In particular, the sought or supplied piece of information may be evidence of prior art or other facts that is relevant to assessing the legal validity of an industrial property right. Particularly citations from patent or non-patent literature or else references to prior public use are possible in this case. The method is not limited to technical property rights, however; references to registered trademarks with earlier priority may also be relevant in connection with trademark conflicts.

The reward can be oriented particularly to the relevance of the supplied piece of information, and in this case the relevance can be calculated on the basis of the role that the supplied piece of information plays in an official or judicial procedure for examining the legal validity of an industrial property right. By way of example, it is thus possible for the supply of prior art that is regarded as prejudicial to the novelty of the whole property right in an opposition or nullity procedure at first instance to be rewarded with [symbol] 5000, whereas the supply of prior art that is regarded as relevant to the assessment of the inventive step of the subject matter of a property right attracts the payment of [symbol] 2000, In this case, the cited sums can be split over a plurality of contributors, so that the cost to the initiator remains calculable at all times.

A further contribution to the calculability of the cost can be made by virtue of only the first supplier of the sought piece of information and, if appropriate, the participants involved in the identification of said supplier receiving a reward or a share of the reward. In this case, it is possible to use the date and time of receipt, of an e-mail containing the sought piece of information by the initiator, for example.

It is additionally possible to register oneself as a participant permanently. In this case, one's own contact data and also fields of interest, for example, can be stored with the initiator, so that suitable search tasks prompt the relevant participant to be informed in automated fashion—for example by an “app” for smartphones. The possibilities of semantic text analysis that have already been addressed above additionally mean that there is the option of providing the initiator itself with drafted documents, such as scientific articles or also property right applications, as a result of which relevant search tasks can be identified for the participant in question and the participant can be contacted.,

### BRIEF DESCRIPTION OF THE DRAWING

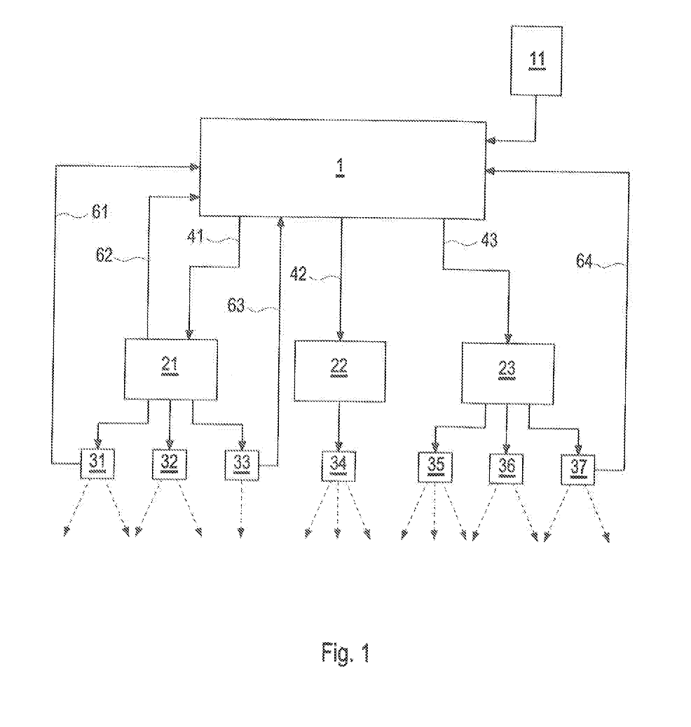

A possible method according to the invention is illustrated briefly below with reference to the flowchart shown in FIG. 1.

### DETAILED DESCRIPTION OF THE PREFERRED EMBODIMENTS

The initiator 1, for example a computer system, is first of all provided with a document 11, for example a patent specification, for semantic analysis. Following completion of the analysis, the initiator uses the database searches addressed above to ascertain the first participants 21-23 and informs the latter about the search query and the conditions thereof, as indicated by the arrows 41-43, Right after this step, it is possible for first results to be reported back to the initiator, as indicated by the arrow 62. In parallel, the participants 21-23 inform further participants 31-37, who for their part are able to supply appropriate reports back to the initiator (arrows 61, 63, 64) and/or on the other hand inform further participants (dashed arrows). The avalanche-like character of the method can clearly he seen in FIG. 1.

As already mentioned, the method described is not limited to the field of industrial property protection. It can be used to obtain information of any kind.

1-9. (canceled)

10. A method for ascertaining a sought piece of information by involving a plurality of participants, the method comprising the step of:
selecting a search task, by an initiator, for a sought piece of information;
sending the search task, from the initiator, for the sought piece of information to a set of participants and identifying a prospect of a reward;
rewarding, with a share of the reward, any participant who supplies the sought piece of information to the initiator in response to the search task; and
also rewarding with a share of the reward any participant who, although that participant did not actually supplying the sought piece of information to the initiator, contribute in identifying the participant who supplies the sought piece of information to the initiator,

11. The method as claimed in claim 10, further comprising rewarding each participant who contributed to contacting the participant who supplies the sought piece of information to the initiator with a share of the reward.

12. The method as claimed in claim 11, further comprising the step of paying the reward to the participants, who contributed with supplying the sought piece of information to the initiator, in different shares.

13. The method as claimed in claim 12, further comprising the step of rewarding the participant who actually supplies the sought piece of information to the initiator with a highest share of the reward.

14. The method as claimed in claim 13, further comprising the step of calculating the share for each participant, who contributed with contacting the participant who supplies the sought piece of information to the initiator, according to a position each respective participant played in contacting the participant who supplies the sought piece of information to the initiator.

15. The method as claimed in one claim 11, further comprising the step of searching for, as the sought or supplied piece of information, evidence of prior art or other facts relevant to assessing legal validity of an industrial property right.

16. The method as claimed in claim 15, further comprising the step of orienting the reward to the relevance of the supplied piece of information.

17. The method as claimed in claim 16, further comprising the step of calculating the relevance on a basis of a role that the supplied piece of information plays in an official or judicial procedure examining legal validity of an industrial property right.

18. The method as claimed claim 11, further comprising the step of paying the reward only to the participant who first supplies the sought piece of information to the initiator.

19. The method as claimed claim 11, further comprising the step of paying a first share of the reward only to the participant who first supplies the sought piece of information to the initiator, and also paying a remaining share of the reward to each participant involved in contributing to identify the participant who first supplies the sought piece of information to the initiator.

20. A method for semi-automatically ascertaining a sought piece of information by involving a plurality of participants via use of a computer, the method comprising the step of:
selecting a search task, by an initiator utilizing the computer, for a sought piece of information;
automatically sending the search task, via the computer, for the sought piece of information to a set of participants and identifying a prospect of a reward supplying the sought piece of information to the initiator;
rewarding, with the reward, a first participant who supplies the sought piece of information to the initiator in response to the search task sent by the computer; and
also rewarding with a share of the reward any participant who, although that participant did not actually supplying the sought piece of information to the initiator, contribute in identifying the participant who supplies the sought piece of information to the initiator.

21. The method as claimed in claim 20, further comprising rewarding each participant who contributed in contacting the participant who supplies the sought piece of information to the initiator with a share of the reward but paying the reward to the participants, who contributed with supplying the sought piece of information to the initiator, in different shares.

22. The method as claimed in claim 21, further comprising the step of rewarding the participant who actually supplies the sought piece of information to the initiator with a highest share of the reward, and
calculating the share for each participant, who contributed with contacting the participant who supplies the sought piece of information to the initiator, according to a position each respective participant played in contacting the participant who supplies the sought piece of information to the initiator.

23. The method as claimed in one claim 22, further comprising the step of searching for, as the sought or supplied piece of information, evidence of prior art or other facts relevant to assessing legal validity of an industrial property right;
orienting the reward to the relevance of the supplied piece of information;
calculating the relevance on a basis of a role that the supplied piece of information plays in an official or judicial procedure examining legal validity of an industrial property right.

24. The method as claimed claim 20, further comprising the step of paying the reward only to the participant who first supplies the sought piece of information to the initiator.

25. The method as claimed claim 20, further comprising the step of paying a first share of the reward only to the participant who first supplies the sought piece of information to the initiator, and also paying a remaining share of the reward to each participant involved in contributing to identify the participant who first supplies the sought piece of information to the initiator.

26. A method for semi-automatically ascertaining a sought piece of information by involving a plurality of participants via use of a computer, the method comprising the step of:
selecting a search task, by an initiator utilizing the computer, for a sought piece of information and the sought piece of information relates to evidence of prior art or other facts relevant to assessing legal validity of an industrial property right;
orienting the reward to the relevance of the supplied piece of information;
calculating the relevance on a basis of a role that the supplied piece of information plays in an official or judicial procedure examining legal validity of an industrial property right.
sending the search task, via the computer, for the sought piece of information to a set of participants and identifying a prospect of a reward for supplying the sought piece of information to the initiator;
having the set of participants contacting other participates to assist with performing the search task for the sought piece of information;
rewarding, with a highest share of the reward, a first participant who supplies the sought piece of information to the initiator in response to the search task sent by the computer;
also rewarding with a share of the reward any participant who, although that participant did not actually supplying the sought piece of information to the initiator, contribute in identifying the participant who supplies the sought piece of information to the initiator, and calculating a share for each participant, who contributed with contacting the participant who supplies the sought piece of information to the initiator, according to a position each respective participant played in contacting the participant who supplies the sought piece of information to the initiator.
